(19) United States
(12) Patent Application Publication
(10) Pub. No.: US 2013/0284828 A1
(43) Pub. Date: Oct. 31, 2013

(54) DEVICE FOR INJECTING FUEL

(71) Applicant: Martin Mueller, Moeglingen (DE)

(72) Inventor: Martin Mueller, Moeglingen (DE)

(21) Appl. No.: 13/879,247

(22) PCT Filed: Sep. 21, 2011
(86) PCT No.: PCT/EP11/66446

§ 371 Date: Jul. 17, 2013

(30) Foreign Application Priority Data
Oct. 14, 2010 (DE) 10 2010 042 476.5

(51) Int. Cl. F02M 51/06

(52) U.S. Cl. CPC F02M 51/0603
USPC 239/584

(57) ABSTRACT

A device for injecting fuel includes an outwardly opening valve needle, a piezo actuator connected to the valve needle, a valve body having a first through-opening, and a holding body connected to the valve body and having a second through-opening. The valve body has a valve seat and a first guide region for guiding the valve needle, the valve needle being disposed in the valve body and in the holding body, and the first through-opening is formed in the valve body without undercutting.

### BACKGROUND OF THE INVENTION

1. Field of the Invention The present invention relates to a device for injecting fuel, having an improved and more economic construction.

2. Description of the Related Art

In the field of direct fuel injection, piezo injectors with outwardly opening valve needle are also being used to an increasing extent. It has been found in that case that it is necessary, on the one hand, to ensure exact guiding of the valve needle and, on the other hand, to ensure a reliable and long-lasting seal between a region filled with fuel and a dry (fuel-free) region of the injector.

### BRIEF SUMMARY OF THE INVENTION

The fuel injection device according to the present invention has by comparison the advantage that it has a distinctly simpler and more economic construction. This provides a very great savings potential in series production. Furthermore, simpler assembly also becomes possible. In accordance with the present invention, this is achieved by virtue of the fact that the device has an outwardly opening valve needle that is actuated by a piezo actuator. In addition, a valve body having a first through-opening and a holding body connected to the valve body and having a second through-opening are provided. The valve needle is disposed in both through-openings. The valve body includes, in addition to a valve seat, also a first guide region for guiding the valve needle. In this case, the first through-opening is provided in the valve body in such a way that the through-opening has no undercutting. In other words, the elongate through-opening is formed in such a way that there are no groove-shaped recesses or the like in the through-opening. As a result, the through-opening may be produced quickly and inexpensively from one side, for example by a multiple-stage drilling process. In addition, it is preferably also possible for a valve seat and the guide region of the valve needle to be ground in a clamping arrangement from one side of the through-opening. In that case it is possible, in particular, to avoid an expensive, two-sided grinding process.

Further preferably, the device includes a bushing disposed in the holding body and having a second guide region at which the valve needle is guided. The second guide region is preferably disposed in this case in the dry region of the device, and therefore it is not necessary to use a corrosion-resistant material for it.

Further preferably, the device includes bellows for sealing off a region filled with fuel from a dry, fuel-free region of the device. In this case, a first end of the bellows is disposed directly on the valve needle. In that manner it is possible to reduce the number of parts since it is not necessary to provide on the valve needle an additional ring or the like for fastening the bellows. The bellows are further preferably made from a single-layer metal material, with the result that it is especially economic. Further preferably, a second end of the bellows is fastened to the bushing disposed on the holding body. It is thus possible that preassembly of the components valve needle, bellows and bushing may already be provided, those components then being capable of being installed in the device as a subassembly.

Further preferably, the device includes a restoring element which is supported on the holding body. The restoring element is preferably a cylindrical spring. The restoring element is further preferably disposed in the dry region of the device. Further preferably, the restoring element is supported on a plate element which is fastened to the valve needle. The plate element is preferably disposed at the opposite end of the valve needle from the injection side.

For especially simple and rapid assembly, the holding body has a first contact face and the valve body has a second contact face. The two contact faces are in contact with each other and are disposed perpendicular to a central axis of the device. In that manner, a planar contact is obtained between the valve body and the holding body, as a result of which a simple and reliable connection of the two components is possible. Especially preferably, the holding body and/or the valve body has a centering collar for simplifying assembly still further.

In accordance with a preferred configuration of the invention, the valve body has, in the axial direction of the device, a length that is smaller than a length of the holding body. Preferably, the length of the valve body is in that case more than half as small as that of the holding body.

Further preferably, the valve needle includes a third guide portion which is guided on a common guide region with the first guide portion in the valve body. The guide region in the valve body is formed in this case over a certain axial length, so that the two guide portions on the valve needle are guided on the guide region.

In accordance with a further preferred configuration of the invention, the device includes a cylinder-ring-shaped flow region which is disposed between the first guide region at the valve body and a fuel outlet. In this case, a cross-sectional area of the ring-shaped flow region is approximately twice as large, and preferably exactly twice as large, as a cylinder-ring-shaped exit area at the fuel outlet. The cylinder-ring-shaped flow region according to the present invention enables the flow of fuel when the valve is open to be made more consistent, since, owing to the provision of the first guide regions, a slight swirling of the fuel stream may occur. This may be throttled in the cylinder-ring-shape flow region. Since the exit area at the fuel outlet is approximately half as large as the cross-sectional area of the cylinder-ring-shaped flow region, further throttling takes place at the outlet, whereby an exactly defined shape of the spray is obtained.

Further preferably, a length of the cylinder-ring-shaped flow region is selected in such a way that the length is approximately two to five times, preferably four times, as long as a width of the cylinder-ring-shaped flow region, the width being defined as the radial distance of the needle from the through-opening of the valve body at the flow region. In that manner it is possible to ensure that the cylinder-ring-shaped flow region is long enough to obtain the desired consistency of the fuel stream when the valve is open.

### BRIEF DESCRIPTION OF THE DRAWINGS

FIG. 1 shows a schematic side view of a device according to the invention for injecting fuel, in accordance with a first exemplary embodiment of the invention.

FIG. 2 shows a schematic, enlarged side view of the device during an injection operation.

FIG. 3 shows a schematic side view of a device according to the invention for injecting fuel, in accordance with a second exemplary embodiment of the invention.

### DETAILED DESCRIPTION OF THE INVENTION

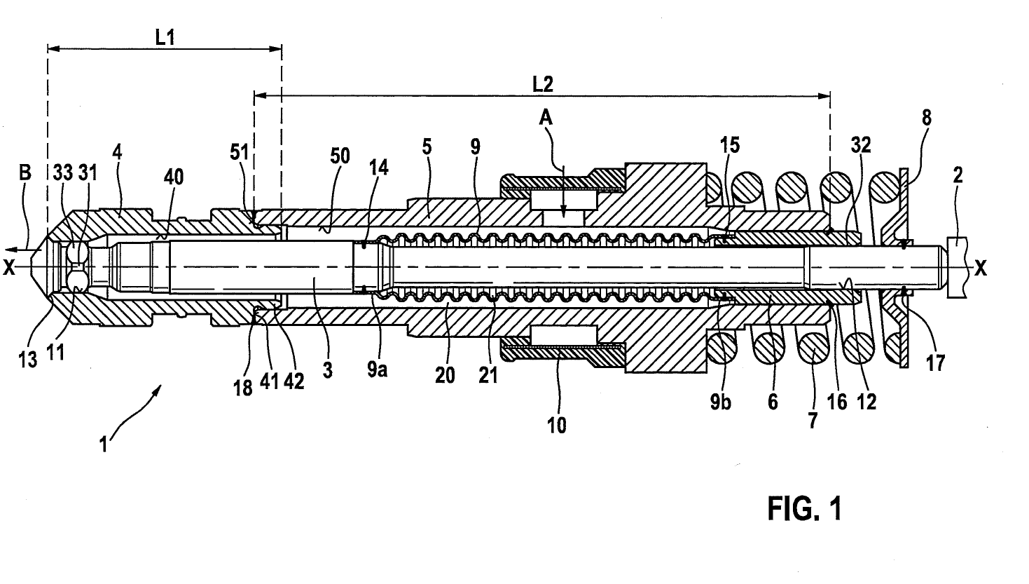

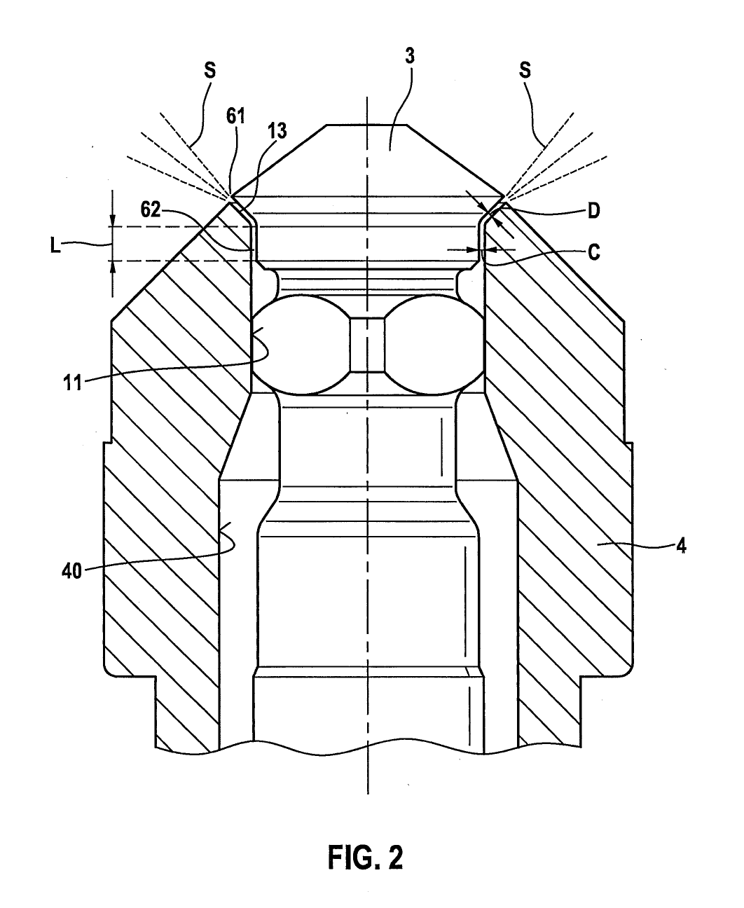

A device 1 for injecting fuel in accordance with a first exemplary embodiment of the invention is described in detail below with reference to FIGS. 1 and 2.

As may be seen from FIG. 1, the device 1 for injecting fuel includes a piezo actuator 2 which is connected to an outwardly opening valve needle 3. Valve needle 3 is a one-piece component which is disposed in a valve body 4 and a holding body 5. In this case, valve body 4 has a first through-opening 40 and holding body 5 has a second through-opening 50. Disposed on valve body 4 is a valve seat 13 on which valve needle 3 rests in the closed state. In this case, a first guide region 11 for guiding valve needle 3 is disposed adjacent to valve seat 13 in through-opening 40. In addition, valve needle 3 is guided at a second guide region 12 which is provided on an inner periphery of a bushing 6. In that region, valve needle 3 has a second guide portion 32. It is pointed out that guide portions 31, 32 and guide regions 11 and 12 have been machined using a fine-machining method in order to exhibit excellent sliding properties. Bushing 6 is connected to holding body 5 by a welded connection 16 and is partially inserted into holding body 5.

Device 1 further includes corrugated bellows 9 made from a single-layer metal material. As may be seen from FIG. 1, corrugated bellows 9 are directly welded by a first end 9a onto valve needle 3 by a welded connection 14. A second, opposite end 9b of corrugated bellows 9 is welded to bushing 6 by a welded connection 15. In this case, bushing 6 has a small shoulder for securely receiving second end 9a. Corrugated bellows 9 divide the injector into a wet region 20, where fuel is present, and a dry region 21, which is fuel-free.

Device 1 further includes a restoring spring 7 which is supported by one end on holding body 5 and by its other end on a spring plate 8. Spring plate 8 is directly fastened to valve needle 3 by a welded connection 17. There is thus formed on the valve needle, starting on the injection side at valve seat 13, first a first guide portion 31, then a sealing region provided by corrugated bellows 9, and then a second guide portion 32. Restoring spring 7 then acts on valve needle 3 after second guide portion 32.

As may further be seen from FIG. 1, reference numeral 10 denotes a filter through which the fuel is supplied, as indicated by arrow A. The fuel is then passed along corrugated bellows 9 and the forward region of valve needle 3 to valve seat 13. In this case, recesses 33 are provided in the valve needle in the region of first guide portion 31 so that the fuel is directly in contact with valve seat 13.

For rapid assembly, a centering collar 42 is furthermore formed on valve body 4. As may be seen from FIG. 1, centering collar 42 is inserted into second through-opening 50 of holding body 5. In addition, a first contact face 41 is formed on valve body 4 and a second contact face 51 is formed on holding body 5, which contact faces 41, 51 are each oriented perpendicular to axial direction X-X. This produces a flat contact face between valve body 4 and holding body 5, so that a connection may be made between valve body 4 and holding body 5 using a welded connection 18.

As may further be seen from FIG. 2, a cylinder-ring-shaped flow region 62 is disposed at valve body 4 between first guide region 11 and a fuel outlet 61. Cylinder-ring-shaped flow region 62 is formed between needle 3 and through-opening 40 of valve body 4. Cylinder-ring-shaped flow region 62 has a ring area C. As may further be seen from FIG. 2, a ring area D perpendicular to the flow direction is present between valve needle 3 and valve seat 13 when the valve is completely open, ring area D being approximately half as large as ring area C. In addition, a length L of cylinder-ring-shaped flow region 62 is approximately four times as large as a width of cylinder-ring-shaped flow region 62. The width is in this case the radial distance between the needle and the wall surface of through-opening 40 at flow region 62. By providing cylinder-ring-shaped flow region 62 it is thus possible to obtain improved flow with reduced swirling when the valve is completely open, so that a spray, denoted by “S” in FIG. 2, may be sprayed out in a defined manner. A radius R is further formed on valve needle 3, at the transition to the cylinder-ring-shaped region.

The function of the injector according to the present invention is as follows. If injection is to take place, piezo actuator 2 is activated, whereby valve needle 3 is moved in the direction of arrow B and is lifted off valve seat 13. Fuel may thereby be injected through the opened injector. The movement of valve needle 3 takes place counter to the spring force of restoring spring 7 which is pre-loaded by the lifting of valve needle 3. If the injection is to be ended again, piezo actuator is deactivated again and the injector is automatically returned by the pre-loaded restoring spring 7 to the starting position shown in FIG. 1 and valve needle 3 rests firmly against valve seat 13 and provides a seal there in known manner.

Thus, in accordance with the present invention, it is possible to provide an outwardly opening injector that has, in particular, a simplified and more economic construction than in the related art. As may further be seen from FIG. 1, a length L1 of valve body 4 in axial direction X-X is smaller than a length L2 of holding body 5 in axial direction X-X. It is thus possible to provide a valve body 4 that is short and of a simple shape, while through-opening 40 in valve body 4 is formed without an undercut. As a result, the through-opening, in particular, may be made in a very simple manner. Since, in addition, sealing seat 13 and first guide region 11 on valve body 4 are directly adjacent to each other, it is also possible for production of those surfaces to take place in a clamping device from the same side. Thus, it is not necessary, as in the related art, to machine two separate guide faces on valve body 4, which makes the manufacture of valve body 4 significantly more expensive. According to the present invention, the side of valve body 4 facing holding body 5 may be produced inexpensively by a turning operation.

In addition, according to the present invention, the closing force of restoring spring 7 may be set in a simple manner by fastening spring plate 8 at an appropriate position on valve needle 3. As may further be seen from FIG. 1, corrugated bellows 9 are disposed entirely within holding body 5. That arrangement makes it possible for corrugated bellows 9 to be provided inexpensively as a one-layer metal element since there is sufficient room in holding body 5 for corrugated bellows 9 to be disposed therein. In particular, it is thereby possible to use corrugated bellows 9 that are relatively long in axial direction X-X. As a result, corrugated bellows 9 are able to have a large number of corrugations so as to be able to adequately absorb the bending strains acting thereon. A further advantage of the present invention is that, according to the invention, it is possible to use bushing 6 which is also of an increased length in axial direction X-X. As a result, a spacing between welded connection 16 to holding body 5 and second guide portion 32 may be greater. As a result, it is possible for bushing 6 to be hardened and tempered since the welding operation does not result in any reduction in hardness at the guide region. The hardened and tempered bushing exhibits less wear in that case, in particular when transverse forces act on valve needle 3. Spring plate 8 may be manufactured very inexpensively as a simple deep-drawn part. In that case it is possible, in particular, to dispense with a spring-centering collar on the spring plate.

Compared with the related art, the injector according to the present invention thus exhibits a large number of improvements which altogether render possible a distinct saving in costs in the manufacture of the injector. In particular, the provision of a valve body 4 free of undercuts significantly lowers production costs.

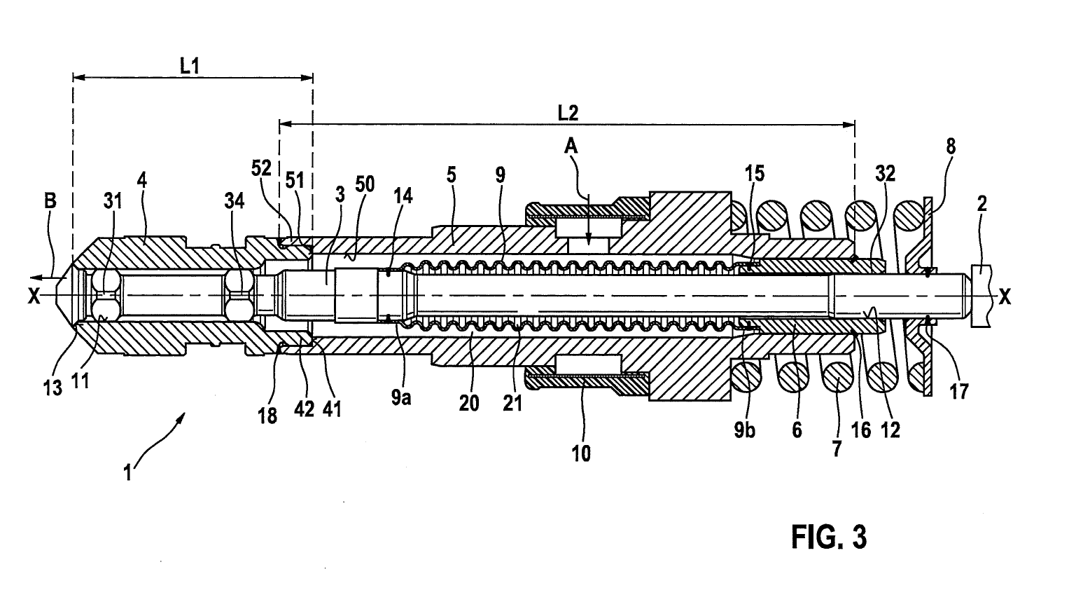

A device 1 for injecting fuel in accordance with a second exemplary embodiment of the invention is described in detail below with reference to FIG. 3. Identical or functionally identical parts are denoted by the same reference numerals as in the first exemplary embodiment.

In contrast to the first exemplary embodiment, the device of the second exemplary embodiment has a third guide portion 34 on valve needle 3. As may be seen from FIG. 3, third guide portion 34 is disposed adjacent to first guide portion 31. At third guide portion 34, valve needle 3 is guided, as in the case of first guide portion 31, on valve body 4. For that purpose, first guide region 11 in through-opening 40 of the valve body is lengthened in axial direction X-X. As a result, although it is necessary to provide a lengthened first guide region 11 in through-opening 40, valve needle 3 is better aligned with the central axis, in particular near valve seat 13. Thus, in turn, in an open state of the device, a seat gap between valve needle 3 and valve seat 13 may be more uniform over the periphery, as a result of which the fuel spray expelled over the periphery is also more uniform. Owing to the small spacing of first and third guide region 31, 33 in valve body 4, however, as in the first exemplary embodiment the guide regions may be ground in a clamping device from the seat side at little cost. A further difference from the first exemplary embodiment resides in the connection between valve body 4 and holding body 5. As may be seen from FIG. 3, there are provided both a centering collar 42 on valve body 4 and a centering collar 52 on holding body 5. In this case, a clearance fit or an interference fit may be provided between centering collar 42 and centering collar 52. When welded connection 18 is being made between valve body 4 and holding body 5, in particular centering collar 52 of holding body 5 heats up more than centering collar 42 of valve body 4 lying radially further inward, since centering collar 52 has a thinner wall in comparison with centering collar 42. As the components cool down, centering collar 52 of holding body 5 therefore shrinks more than does valve body 4. As a result, valve body 4 is drawn onto axial contact face 51 on holding body 5 and therefore is aligned very accurately. Since the welding operation is relatively far away from contact faces 41, 51 in axial direction X-X, different welding distortions along the periphery have only a very minor effect, if any, on a non-axial alignment of valve body 4 with respect to holding body 5.

1-12. (canceled)

13. A device for injecting fuel, comprising:
an outwardly opening valve needle;
a piezo actuator connected to the valve needle;
a valve body having a first through-opening; and
a holding body connected to the valve body and having a second through-opening;
wherein the valve body has a valve seat and a first guide region for guiding the valve needle, and wherein the valve needle is disposed in the valve body and in the holding body, and wherein the first through-opening is formed in the valve body without undercutting.

14. The device as recited in claim 13, wherein a second guide region is provided at which the valve needle is guided, the second guide region being formed at a bushing disposed in the holding body.

15. The device as recited in claim 14, further comprising:
corrugated bellows configured to seal off a first region filled with fuel from a second region which is fuel-free, wherein a first end of the corrugated bellows is fastened directly to the valve needle.

16. The device as recited in claim 15, wherein the bellows are made of a single-layer metal material.

17. The device as recited in claim 15, wherein a second end of the corrugated bellows is fastened to the bushing disposed in the holding body.

18. The device as recited in claim 15, further comprising:
a restoring element supported at one end on the holding body.

19. The device as recited in claim 18, further comprising:
a plate element made of sheet metal and fastened directly to the valve needle, wherein the restoring element is supported on the plate element.

20. The device as recited in claim 15, wherein the valve body has a first contact face and the holding body has a second contact face, and wherein the first and second contact faces are in contact with each other and disposed perpendicular to a central axis of the device.

21. The device as recited in claim 15, wherein the valve body has a length which is smaller than a length of the holding body.

22. The device as recited claim 15, wherein the valve needle has a two adjacent guide portions which are guided on the first guide region.

23. The device as recited in claim 15, further comprising:
a cylinder-ring-shaped flow region disposed between the first guide region and the valve seat, wherein an area of the cylinder-ring-shaped flow region is approximately twice as large as a cylinder-ring-shaped exit area at the valve seat when the valve needle is completely open.

24. The device as recited in claim 23, wherein the cylinder-ring-shaped flow region has a length that is approximately two to five times as long as a width of the cylinder-ring-shaped flow region.
